(19) United States
(12) Patent Application Publication
(10) Pub. No.: US 2011/0020141 A1
(43) Pub. Date: Jan. 27, 2011

(54) MICROFLUIDIC DEVICE AND METHOD

(75) Inventors: Hans Van Zon, Eindhoven (NL); Murray Fulton Gillies, Eindhoven (NL); Cristian Bogdan Craus, Eindhoven (NL); Stefano Cattaneo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/933,889

(22) PCT Filed: Mar. 25, 2009
(86) PCT No.: PCT/IB09/51235

§ 371 Date: Sep. 22, 2010

(30) Foreign Application Priority Data
Mar. 28, 2008 (EP) 08153483.6

(51) Int. Cl. H02K 44/00

(52) U.S. Cl. 417/50

(57) ABSTRACT

The present invention relates to a microfluidic device and a corresponding method for pumping of high conductivity liquids comprising: —a microfluidic channel (26; 80; 101) for containing an electrically conductive liquid, in particular a liquid having a high conductivity, —at least two electric field electrodes (21, 22; 71, 72; 91, 92) for generating electric fields, —at least one magnetic field electrode (21, 22; 75, 76; 93, 94) for generating a magnetic field in a direction substantially perpendicular to said electric fields, —a voltage source (23; 74; 95) for providing electric potentials to said at least two electric field electrodes (21, 22; 71, 72; 91, 92) for generating said electric fields, —a current source (23; 78, 79; 96, 97) for providing an electric current to said at least two magnetic field electrodes (21, 22; 75, 76; 93, 94) for generating said magnetic field, wherein said voltage source (23; 74; 95) and said current source (23; 78, 79; 96, 97) are adapted to simultaneously provide said electric potential and electric current, respectively, to said electrodes to obtain a Lorentz force acting on the high conductivity liquid in the direction (27; 81; 99) of said microfluidic channel (26; 80; 101).

### FIELD OF THE INVENTION

The present invention relates to a micro fluidic device and a corresponding method for pumping of high conductivity liquids.

### BACKGROUND OF THE INVENTION

Handheld medical devices e.g. for Point-of-Care testing are becoming more and more of interest. In these devices high conductivity liquid samples such as blood or saliva have to be analyzed for specific biomarkers or biomolecules to indicate the health status of the person. The volume of the liquid samples is small and manipulation of the liquid is done in microfluidic channels and chambers. Manipulation typically includes transport of the liquid from the inlet port to the measurement site and mixing of several liquids. While in some cases the capillary force can be utilized many applications require active pumping for either transport or mixing.

Active pumping mechanisms are typically divided into mechanical and non-mechanical pumps. Non-mechanical pumps have the advantage that they do not require any moving parts in the device. In these type of devices the movement of liquid or particles in the liquid (such as polystyrene or latex beads or cells) is normally done by means of magnetic and/or electric fields either static (DC) or at higher frequencies (AC) with or without phase differences (travelling waves) between the electrodes. Examples of techniques which use electric fields are electrophoresis, dielectrophoresis, electro-osmosis and electrothermal fluid flow; the last three principles are typically denoted with the term AC electrokinetics, electrothermal methods are sometimes also referred to as electrohydrodynamic pumping or EHD. These techniques only require an electrode configuration on a single substrate without the necessity of external components and are therefore very simple and easy to integrate.

An important distinction between these effects is that electrophoresis and dielectrophoresis both work directly on particles situated in the liquid rather than the liquid itself and therefore do not constitute liquid pumping. This is a disadvantage because the pumping effect strongly depends on the properties of both the particles and the liquid. Electro-osmosis and electrothermal pumping do however pump the liquid directly.

An important parameter to consider when selecting a pump effect for use in a bioassay is the conductivity of the liquid. Both blood and saliva are high conductivity liquids and as such make electro-osmosis and even electrothermal fluid flow extremely difficult or even impossible. So there is currently not a good technique based on simple electrodes only which is able to pump high conductivity liquids.

In the past few years there has been a growing interest of the application of magnetohydrodynamic (MHD) fluid flow in microfluidic devices. Relevant prior art can be found in U.S. Pat. No. 6,780,320 B2, U.S. Pat. No. 6,146,103, US 2007/0105239A1 and U.S. Pat. No. 6,733,172 B2. In this technique a combination of an electric and magnetic field is used to create a Lorentz force on the ionic species in the liquid and therefore these techniques pump the liquid directly. To create a continuous Lorentz force in one direction and achieve a net pumping effect, either both the electric and magnetic field have to be static in one direction (DC application) or they have to be reversed synchronously (AC application).

In DC MHD pumps, the magnetic field is usually produced by means of an external permanent magnet. DC electric fields, however, do not easily penetrate liquids with high concentrations of charged species and a current can only be drawn when hydrolysis (charge neutralization) occurs at the electrodes. Hydrolysis creates gas bubbles in the fluid and is not a desired effect in microfluidics because bubbles disturb or even can block the liquid flow. High frequency electric fields can more easily penetrate liquids with a high ionic content because they can bypass the double layer capacitance built up at the electrode surface.

For AC MHD pumping, however, the magnetic field has to oscillate with the same frequency and phase as the electric field. A permanent magnet cannot be used in this case so electromagnets have to be used. These electromagnets are bulky, consume a lot of power, are not integrated directly onto a substrate and cannot easily be oscillated above 10 kHz due to their high inductance.

### SUMMARY OF THE INVENTION

It is an object of the present invention to provide an improved micro fluidic device and method, in particular having a simpler and smaller design.

In a first aspect of the present invention a microfluidic device for pumping of high conductivity liquids is presented comprising:

a microfluidic channel for containing an electrically conductive liquid, in particular a liquid having a high conductivity,

at least two electric field electrodes for generating electric fields,

at least one magnetic field electrode for generating a magnetic field in a direction substantially perpendicular to said electric fields,

a voltage source for providing electric potentials to said at least two electric field electrodes for generating said electric fields,

a current source for providing an electric current to said at least one magnetic field electrode for generating said magnetic field,

wherein said voltage source and said current source are adapted to simultaneously provide said electric potential and electric current, respectively, to said electrodes to obtain a Lorentz force acting on the high conductivity liquid in the direction of said micro fluidic channel.

In a further aspect of the present invention a corresponding method is presented.

Preferred embodiments of the invention are defined in the dependent claims. It shall be understood that the claimed method has similar and/or identical preferred embodiments as defined in the dependent claims of claim 1.

The present invention is based on the idea to enable the pumping of high conductivity liquids such as blood and saliva by using simple electrodes only. In ease of manufacturing on a single substrate, the present invention is comparable with the AC kinetics techniques, but it uses the magnetohydrodynamic effect without the necessity of an external (permanent or electro-) magnet. Therefore, the present invention has no restriction on the frequencies to be used (at least the frequencies which can be used are several orders of magnitude higher than those achievable with electromagnets) and it does not require special measures to synchronize the phase of the electric and magnetic fields.

The present invention provides an integrated MHD pump and pumping method which offer the advantage that it is very well suited for the pumping of high conductivity liquids such as blood or saliva. Further, instead of using permanent or electromagnets, which are external to the microfluidic device, magnetic fields are used, which are generated on the substrate itself by means of currents sent through the electrodes. The large advantage is the low inductance of the electrodes with respect to the external electromagnets, enabling higher frequencies which make it easier to penetrate high conductivity liquids.

According to preferred embodiments at least two magnetic field electrodes are provided, wherein said at least two electric field electrodes and said at least two magnetic field electrodes are the same. This embodiment makes the process for making the device, in particular of the electrodes on the substrate, easier. The electric and magnetic field are thus generated by the same electrode configuration. As a consequence, the electric and magnetic fields are automatically synchronized, i.e. there is no phase difference between both fields, enabling the maximum Lorentz force without the necessity of special electronics to bring the magnetic field and the electric field in phase. This is a large advantage, especially at high frequencies (>1 MHz) where phase differences can easily occur due to spurious inductances and capacitances in the circuit.

Preferably, said at least two electric field electrodes and said at least one magnetic field electrode are all provided on the same surface of a single substrate, which also makes fabrication easier.

Advantageously, said electrodes are arranged in parallel and/or coplanar. The electric and magnetic fields are dependent on distance. E.g. if the distance between the voltage-carrying electrodes is enlarged, the electric field will be weaker. Therefore, if the electrodes are not parallel but have a varying distance between them, the electric field will change along the electrodes. The same holds for the magnetic field. Parallel electrodes therefore provide constant conditions along the length of the electrodes (provided, of course, that current and potential are constant).

A coplanar electrode geometry is preferably used instead of a parallel-plate configuration. A coplanar geometry requires the processing of electrodes on one side of the substrate only and does not require vertical wall processing with micromachining, making the lithography process much easier and allowing a larger choice of substrates, such as e.g. PCBs. This geometry also requires no crossovers and can therefore be fabricated with one metal mask step (if lithography is used rather than PCB).

Further, the proposed coplanar electrode geometry automatically generates electric and magnetic fields which are aligned more or less perpendicular to each other, allowing a large Lorentz force, irrespective of the shape of the channel. The liquid flow is defined by the shape of the electrodes. By means of the coplanar electrode structure the fluid can e.g. easily be guided around (sharp) corners.

In a preferred embodiment, said voltage source and said current source are a common power source for providing said electric potential and said electric current. In such an embodiment, no separate means for control and synchronization of the (separate) voltage and current sources are required. Further, the pumping device only requires two electric terminals making the embodiment very simple, i.e. common electrodes are used for generating the electric fields and the magnetic fields.

In another embodiment, in particular having separate voltage and current sources, a control unit is provided for controlling said voltage source and said current source to simultaneously provide said electric potential and electric current, respectively, to said electrodes. Such a control unit can be used in embodiments having separate magnetic field electrodes and electric field electrodes, but also in embodiments having common electrodes.

Preferably, the thickness of said electrodes is larger than 1 μm, in particular larger than 5 μm enabling a much larger Lorentz force than known embodiments where the electrodes are typically much thinner.

Further, an impedance element, in particular a resistor, can be provided at ends of the at least two electric field electrodes. In this way the length of the respective electrode(s) can be made shorter.

### BRIEF DESCRIPTION OF THE DRAWINGS

These and other aspects of the invention will be apparent from and elucidated with reference to the embodiment(s) described hereinafter. In the following drawings

FIG. 1 shows a perspective view of the known MHD cell,

FIG. 2 shows a cross section of a first embodiment of an MHD cell according to the present invention,

FIGS. 3a and 3b show top views of electrode structures used in known AC electrokinetics cells,

FIG. 4 shows top views of electrode structures used in embodiments of MHD cells according to the present invention,

FIG. 5 shows a diagram depicting the Lorentz force dependency with geometry factors thickness and length,

FIG. 6 shows a cross section of a second embodiment of an MHD cell according to the present invention,

FIG. 7 shows a cross section of a third embodiment of an MHD cell according to the present invention,

FIG. 8 shows a cross section of a fourth embodiment of an MHD cell according to the present invention,

FIG. 9 shows a cross section of a fifth embodiment of an MHD cell according to the present invention,

FIG. 10 shows a cross section of a sixth embodiment of an MHD cell according to the present invention, and

FIG. 11 shows a cross section of a eighth embodiment of an MHD cell according to the present invention.

### DETAILED DESCRIPTION OF THE INVENTION

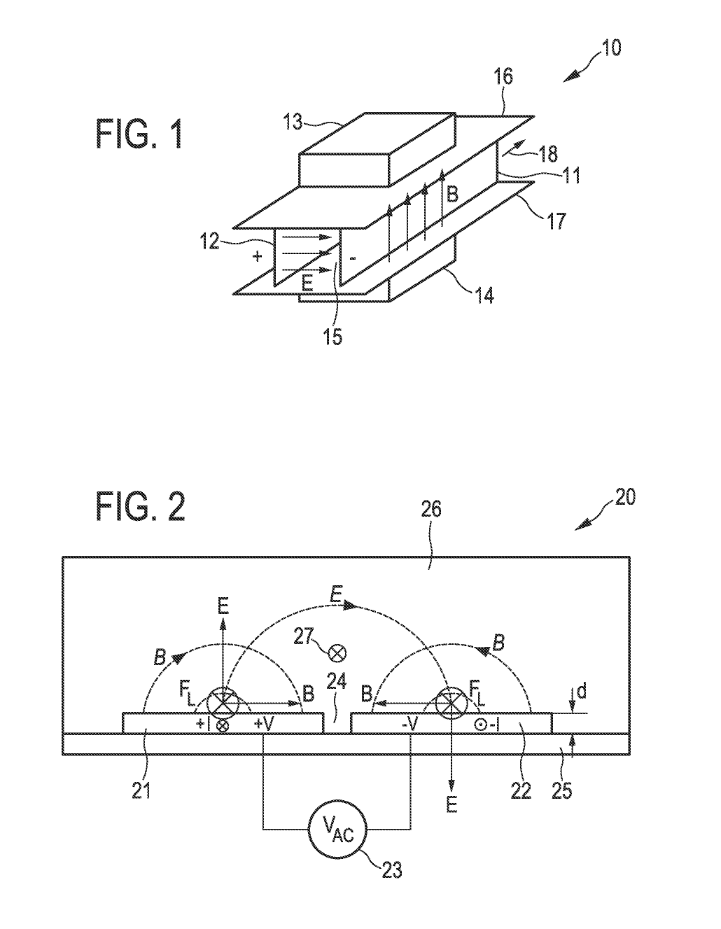

FIG. 1 schematically shows a perspective view of a known MHD cell 10 by use of which the magnetohydrodynamic effect shall be briefly explained. This MHD cell 10 comprises two parallel electrode plates 11, 12 for generating an electric field E and external magnets 13, 14 for generating a homogeneous magnetic field B perpendicular to the channel direction, said channel 15 being defined by said parallel electrode plates 11, 12 and parallel channel plates 16, 17 arranged perpendicular to said electrode plates 11, 12. This requires either the processing of electrodes on both sides of the channel 15 or it requires micromachining (deep trench etching) in combination with lithography to create the parallel-plate configuration.

The magnetohydrodynamic effect is based on the well-known formula for the Lorentz force

\vec{F}=e\vec{ν}×\vec{B}

which states that a force is exerted on a particle with charge e when it is moving with a velocity ν in a magnetic field with induction B. The direction of the force is perpendicular to both the direction of the velocity and the direction of the magnetic induction as given by the right-hand rule. The charged particle normally gains velocity in an electric field because of Coulombic attraction. The direction of the velocity is thus determined by the direction of the electric field. In order to create a Lorentz force it is necessary to have crossed electric and magnetic fields. Moreover, in order to achieve a fluid transport in a microfluidic channel the Lorentz force has to be directed along the channel direction. This is done in the MHD cell 10 shown in FIG. 1 by applying the magnetic field B perpendicular to the channel direction 18 while a crossed electric field E is generated by the two parallel electrode plates 11, 12.

FIG. 2 shows a cross-section of an embodiment of an MHD cell 20 according to the present invention using a coplanar electrode geometry. Both electrodes 21, 22 with a certain thickness d are provided on a surface of a substrate 25 facing the inner side of the microfluidic channel 26 having a channel direction 27. Within the channel 26 a fluid (e.g. blood, saliva, urine, sweat, cerebro spinal fluid or buffer solutions for use in assays) having a high electric conductivity (e.g. >0.1 S/m) to be pumped is provided. Human fluids have typically a relatively high conductivity: blood 1.1-1.7 S/m, saliva 0.45-0.55 S/m or cerebro spinal fluid 2 S/m.

The electrodes 21, 22 are connected to an AC power source 23, which—as an example—provides a power signal, in particular electric potentials +V, −V (i.e. a voltage difference) having a voltage amplitude smaller than 20V (peak-to-peak), and an electric current +I, −I having a current amplitude smaller than 500 mA (peak-to-peak), to said electrodes 21, 22. The electric fields E and the magnetic fields B are drawn for one polarity of the power source 23 only. However, it can be seen easily that a reversal of the polarity will result in a direction change of the magnetic as well as the electric field, thus keeping the Lorentz force F_{L} in the same direction, the direction of the Lorentz force F_{L} corresponding to the channel direction 27.

The main pumping effect takes place near the edges of the electrodes 21, 22 in the gap 24 where the magnetic fields B and the electric fields E are the highest and perfectly perpendicular to each other. This results in a maximum fluid velocity in the gap 24 between the electrodes 21, 22, but also above the electrodes the fluid velocity is still quite substantial.

It should be noted that the cross-section configuration as sketched in FIG. 2 is basically the same as is typically used in AC electrokinetics, i.e. two electrodes with an AC voltage source in between. It is essential to understand that while the cross-sectional views may be the same, the planar designs of the AC electrokinetics and the proposed integrated MHD cell used for pumping are different, as will be shown. The structures for AC electrokinetics work via voltage driving and the planar design is such so as to minimize currents flowing through the electrodes to avoid voltage drops across the electrodes. For the proposed integrated MHD design, however, these currents are not avoided but used to generate a magnetic field in order to make use of the Lorentz force.

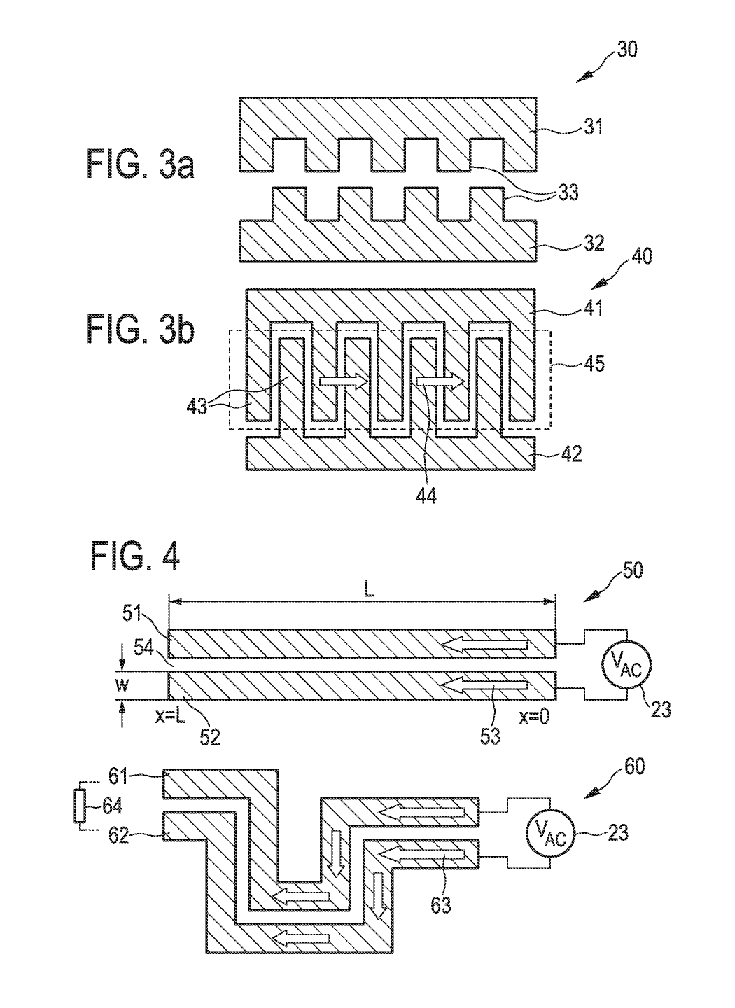

Typical planar configurations (top-view) used in AC eletctrokinetics cells 30, 40 employing AC electrokinetics are using castellated electrodes 31, 32 as shown in FIG. 3a or interdigitated electrodes 41, 42 as shown in FIG. 3b. The currents running in the ‘fingers’ 33, 43 are low. The main driving component is the electric field (or field gradient). This field is the strongest between the electrodes and near the electrode edges. Observed liquid or particle flow is therefore always perpendicular to the electrodes (as indicated by the arrow 44 in FIG. 3b). If flow is required along a fluidic channel with such an electrode configuration, the electrodes have to be positioned perpendicular to the channel 45. The length of the ‘fingers’ 33, 43 are therefore mainly determined by the width of the fluidic channel 44 which is typically smaller than a few mm.

In case of the proposed integrated MHD effect, the Lorentz force is along the length direction of the electrodes, i.e. the fluid motion 53, 63 is along the length direction of the electrodes 51, 52, 61, 62 as indicated in FIG. 4 for two embodiments 50, 60 of electrode configurations according to the present invention. This means that the fluid motion 53, 63 is perpendicular with respect to the motion observed in AC electrokinetics, which can be easily observed. To obtain a flow in the direction of the fluidic channel the electrodes 51, 52, 61, 62 are positioned parallel to the length direction of the channel which can also easily be observed. So, despite the fact that the electrode configuration in cross-section as shown in FIG. 2 is the same as for AC electrokinetics, the planar geometry of the electrodes with respect to the fluidic channel and the observed flow direction are different.

The layout stimulates a current running through the electrodes. To avoid power dissipation and heat generation, the thickness d of the electrodes 51, 52, 61, 62 is chosen much thicker as is the case in AC electrokinetics. Also, thicker electrodes will reduce the impedance of the geometry, allowing larger currents at a certain driving voltage, which will be shown and explained below.

Assuming a configuration of two parallel electrodes 51, 52 having a width W and a length L as is shown in FIG. 4a. The gap 54 between the electrodes 51, 52 is assumed to be small (e.g. smaller or equal to W) to allow an easy description of the electric field. When the electrodes 51, 52 are brought into contact with the liquid, current will flow both through the metal of the electrodes 51, 52 and through the liquid. It is further assumed that the frequency is such that the network can be regarded as purely resistive (for low and high frequencies this will be less valid). The current and voltage distribution in the metal electrodes 51, 52 can be calculated by the following differential equations:

$$\frac{d V ( x )}{d x} = - I ( x ) \cdot \frac{{R}_{0}}{L} and \frac{d I ( x )}{d x} = - V ( x ) \frac{2 σ}{π} \qquad ( 1 , 2 )$$

where R₀ is the resistance of one electrode line 51 or 52, L is the length of the electrode and a is the conductivity of the liquid. Note that the ratio R₀/L is in fact determined by the thickness d and the width W of the electrode and the resistivity p of the electrode material because

$${R}_{0} = \frac{ρ}{d} \cdot \frac{L}{W} \qquad ( 3 )$$

Equation 1 describes the potential drop across the line, while equation 2 describes the drop in current in the line due to current loss through the liquid. It is assumed that the electric field lines between the electrodes 51, 52 can be described by half-circle like patterns which is the case when the gap 54 between the electrodes 51, 52 is small. The differential equations can be solved for the following boundary conditions:

V(x=0)=V₀ and I(x=L)=0 (4)

which state that the entry voltage is V₀ and that at the end of the electrode line no current flows. The electrode structure with the liquid can also be regarded as a ladder network of resistors. This will lead to the same equations. The net result is that the current as well as the voltage drop along the metal electrodes. The solution for the current distribution I(x) depends on the resistivity of the metal, the conductivity of the liquid, the thickness of the electrodes and the length and width of the electrodes, as given by:

$$I ( x ) = \frac{2 {V}_{0} σ}{π \sqrt{α}} {e}^{- x \sqrt{α}} ( \frac{1 - {e}^{2 ( x - L ) \sqrt{α}}}{1 + {e}^{- 2 L \sqrt{α}}} ) ; α = \frac{2 σρ}{π d W} \qquad ( 5 )$$

The voltage V(x) can easily be derived by differentiating I(x) and applying equation 2. Dividing V(0) by I(0) will yield an expression for the total impedance of the structure. The total resistive impedance is then given by:

$$R = \sqrt{\frac{π {R}_{0}}{2 L σ}} = \sqrt{\frac{πρ}{2 d W σ}} \qquad ( 6 )$$

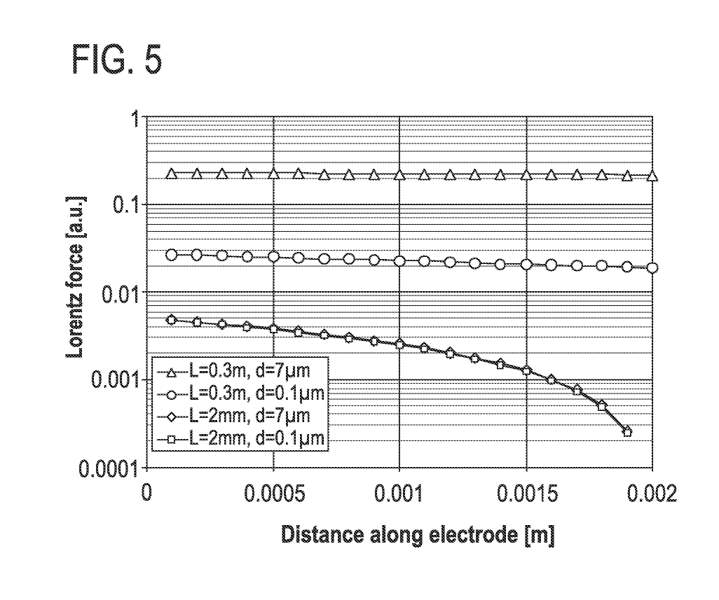

The Lorentz force scales with the product of the electric and magnetic field. The electric field is determined by V(x), while the magnetic field is linearly dependent on the current I(x). FIG. 5 plots the product I(x)·V(x) in arbitrary units as a function of distance along the electrode for various values of the electrode thickness d and length L of the electrodes. All graphs are calculated for the same voltage at the inlet and for the same conductivity of the liquid. It can be seen that just the combination of a long electrode length and thick electrode material will give rise to a large Lorentz force. The electrodes used in AC electrokinetics are typically thin (0.1 μm) and only a few mm long (the width of the fluidic channel, see FIG. 3). Under these conditions the Lorentz force is at least an order of magnitude lower.

In contrast, the meandering structures as e.g. indicated in FIG. 4b have been made on PCB material. In a practical embodiment the electrodes have a total length of 30 cm (folded into a small area) and a thickness of 7 μm. At a voltage of 1.4 V. and a frequency between 100 kHz-10 MHz fast fluid movement of a high conductivity fluid (σ=4 S/m) is observed with speeds in the range of 50-100 μm/sec over at least a length of several centimeters.

The length of the structure is responsible for the creation of a considerable current at the beginning of the structure, as given by equation 5. The length can be reduced to any desirable length by cutting the structure at a certain position and terminate it with an equivalent impedance 64, e.g. a resistor.

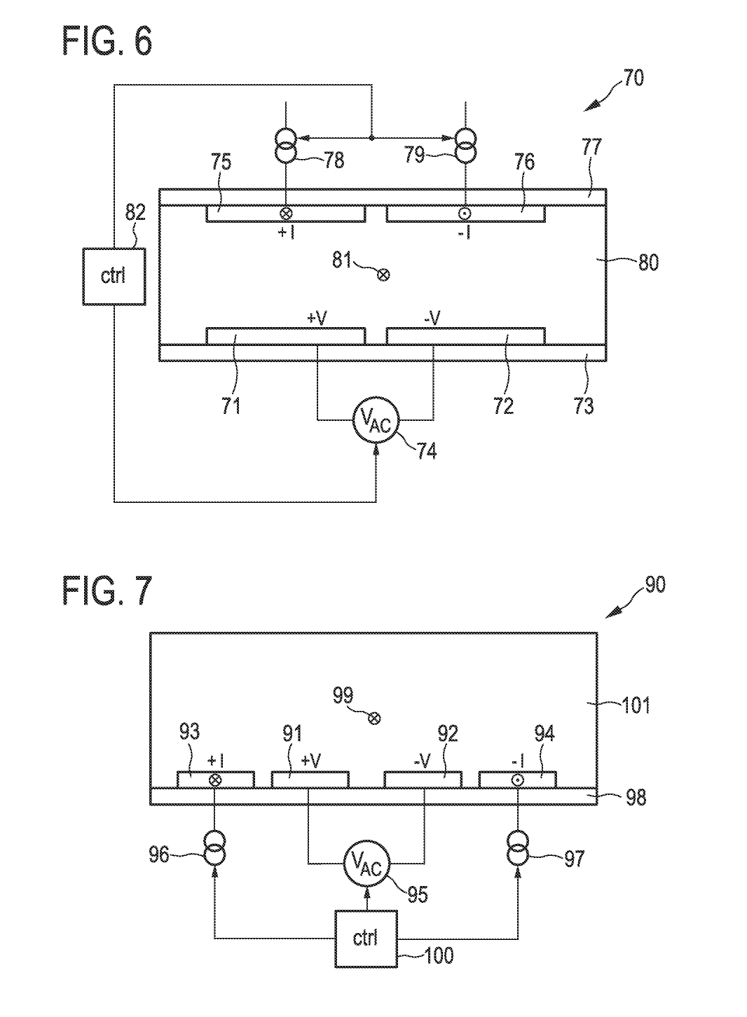

A cross-section of a further embodiment of an MHD cell 70 according to the present invention is shown in FIG. 6. There are now two substrates 73, 77 provided on opposite sides within the microfluidic channel 80, each substrate 73, 77 carrying two parallel planar electrodes 71, 72, 75, 76. In particular, the lower substrate 73 carries two electric field electrodes 72, which are provided with an electric potential +V, −V from the voltage source 74 to generate an electric field E in between similarly as shown in FIG. 2. The upper substrate 77 carries two magnetic field electrodes 75, 76, each being coupled to a respective current source 78, 79 for providing the electrodes with a current +I, −I running through the respective magnetic field electrode 75, 76. To avoid that the magnetic fields generated by these currents +I, −I compensate each other, the currents +I, −I must run in opposite directions as shown in FIG. 6.

An additional control unit 82 is provided in this embodiment to control the voltage source 74 and the current sources 78, 79 to simultaneously provide the electric potential +V, −V and the electric currents +I, −I, respectively, so that a Lorentz force in the direction 81 of the channel 80 is generated.

A cross-section of a third embodiment of an MHD cell 90 according to the present invention is shown in FIG. 7. In this embodiment only one substrate 98 is provided within the microfluidic channel 101 carrying all electrodes 91-94. In particular, the substrate 98 carries on its surface a pair of electric field electrodes 91, 92 provided with an electric potential +V, −V from a voltage source 95 and magnetic field electrodes 93, 94 provided with electric currents +I, −I from separate current sources 96, 97.

Similarly as in the embodiment shown in FIG. 6, a control unit 100 is provided for control of the voltage source 95 and the current sources 96, 97 to simultaneously provide the electric potential +V, −V and the electric currents +I, −I, respectively. Thus, a Lorentz force is generated in the direction 99 of the channel 101.

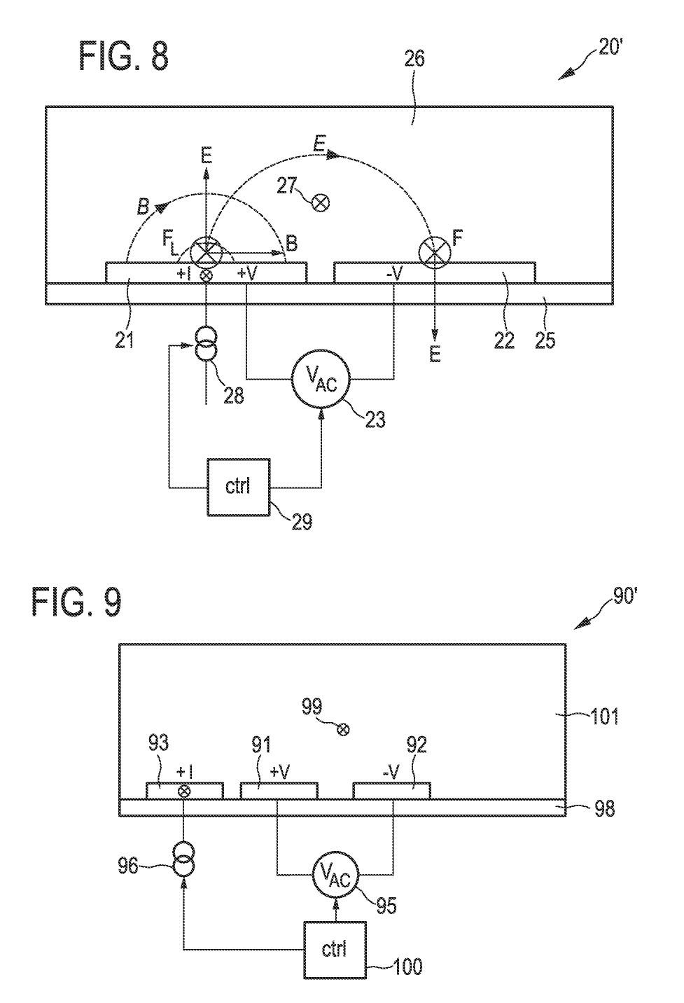

FIG. 8 shows a cross section of a fourth embodiment of an MHD cell 20′ according to the present invention. This embodiment is quite similar to the embodiment shown in FIG. 2, but in the present embodiment a voltage source 23 for providing the electric potential +V, −V to the electrodes 21, 22 and a current source 28 for providing a current +I to only the electrode 21 are separately provided. Further, a control unit 29 for synchronizing the voltage source 23 and the current source 28 are provided.

Hence, according to this embodiment, a magnetic field B is only generated by the current +I through the electrode 21 which is generally sufficient for generating—in combination with the electric field E—a Lorentz force.

FIG. 9 shows a cross section of a fifth embodiment of an MHD cell 90′ according to the present invention. This embodiment is quite similar to the embodiment shown in FIGS. 7 and 8. The present embodiment, however, comprises only a single magnetic field electrode 93 and a single current source 96, separate from the electric field electrodes 91, 92 and the voltage source 95. Thus, like in the embodiment shown in FIG. 8, only one current +I is provided for generating a magnetic field B.

This is one example of a more general case which is that of two coplanar substrates opposite to each other in such a way that magnetic and electric fields enhance each other. With respect to an embodiment with opposite sides, there are 2 configurations: a) two coplanar substrates where each individual coplanar substrate provides a Lorentz force, and (b) one side carries the voltage-driven electrodes while the other side carries the current-driven electrodes. In this case both sides are necessary to provide the Lorentz force.

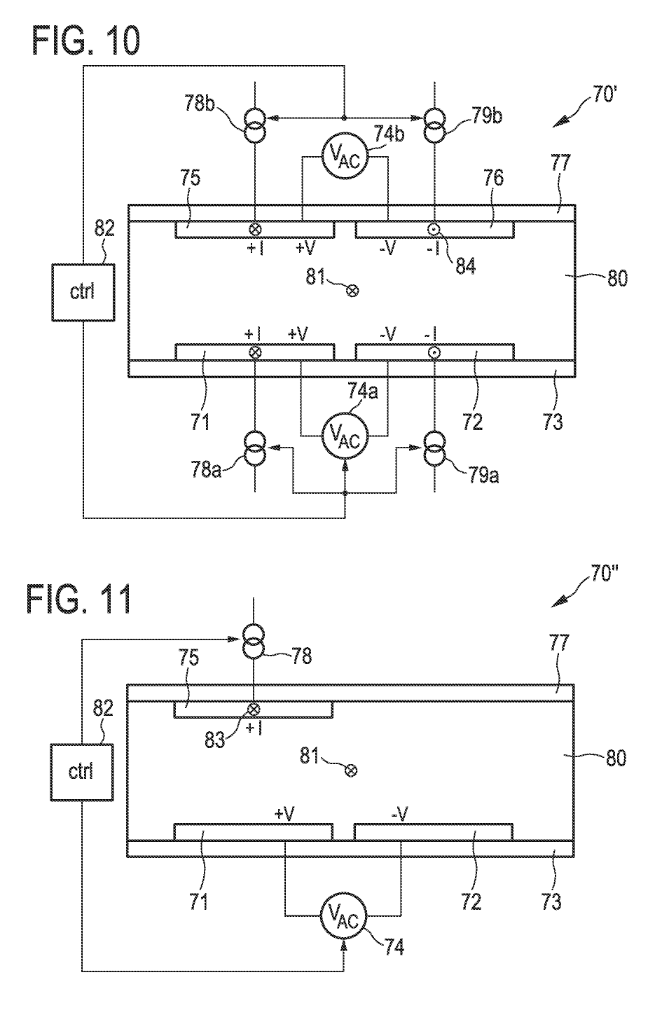

FIG. 10 shows a cross section of a sixth embodiment of an MHD cell 70′ according to the present invention. This embodiment is quite similar to the embodiment shown in FIG. 6. According to the present embodiment, however, all electrodes 71, 72, 75, 76 are both provided with an electric current +I, −I and an electric voltage +V, −V thus generating useful magnetic and electric fields in a large area within the chamber 80. For this purpose separate voltage sources 78a, 79a 78b, 79b and separate voltage sources 74a, 74b are provided, all being controlled (synchronized) by the control unit 82. It would, however, also be possible to use only one voltage source and two current sources.

FIG. 11 shows a cross section of a eighth embodiment 70″ of an MHD cell according to the present invention. This embodiment is also quite similar to the embodiment shown in FIG. 6, but now contains only a single magnetic field electrode 75 and a single current source 78.

To conclude, the pumping of high conductivity fluids is essential for most microfluidic bioassays. Many different effects for active pumping of biological fluids have been investigated. It has been found that the integrated MHD pump as proposed according to the present invention is the only and best realistic choice.

According to the present invention the Lorentz force, resulting from the simultaneous presence of an electrical and magnetic field, is used for pumping. The direction of the force and thus of the movement of the liquid (and, if present, particles within the liquid) is perpendicular to both the magnetic the electric fields. In order to function with conductive liquids, high frequencies are preferably used. To preserve the direction of the Lorentz force, the electric and magnetic fields are synchronized accurately, changing direction in exactly the same time. Using only one source (as in one embodiment of the invention) automatically achieves this, but separate (controlled or synchronized) sources can be used as well. The fluid flow is established by the Lorentz force working on the ionic content of the liquid. Any particles which are present in the liquid are dragged along by the liquid itself.

It shall be noted that the term “electrode” in the above shall be understood as a means that is able to conduct an electric current and have an electric potential at the same time, i.e. it shall be understood that other means, such as wires, shall be comprised by this term as well.

As explained above in detail, in case the electrodes for potential and current are separated, it is clear that also separate voltage and current sources are required which need to be synchronized. In case the electrodes for potential and current are combined, there are two choices:

a) still separate potential and current sources which again need synchronization;
b) the current is provided by the voltage source because a voltage which is put across a resistive liquid will generate current in the liquid and thus in the electrode. In this case there is only one source which provides both potential and current and no synchronization is required. This is the preferred solution.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measured cannot be used to advantage.

Any reference signs in the claims should not be construed as limiting the scope.

1. Microfluidic device for pumping of high conductivity liquids comprising:
a microfluidic channel (26; 80; 101) for containing an electrically conductive liquid, in particular a liquid having a high conductivity,
at least two electric field electrodes (21, 22; 71, 72; 91, 92) for generating electric fields,
at least one magnetic field electrode (21, 22; 75, 76; 93, 94) for generating a magnetic field in a direction substantially perpendicular to said electric fields,
a voltage source (23; 74; 95) for providing electric potentials to said at least two electric field electrodes (21, 22; 71, 72; 91, 92) for generating said electric fields,
a current source (23; 78, 79; 96, 97) for providing an electric current to said at least one magnetic field electrode (21, 22; 75, 76; 93, 94) for generating said magnetic field, wherein said voltage source (23; 74; 95) and said current source (23; 78, 79; 96, 97) are adapted to simultaneously provide said electric potential and electric current, respectively, to said electrodes to obtain a Lorentz force acting on the high conductivity liquid in the direction (27; 81; 99) of said microfluidic channel (26; 80; 101).

2. Microfluidic device as claimed in claim 1,
comprising at least two magnetic field electrodes (21, 22; 75, 76; 93, 94).

3. Microfluidic device as claimed in claim 2,
wherein said at least two electric field electrodes (21, 22) and said at least two magnetic field electrodes (21, 22) are the same.

4. Microfluidic device as claimed in claim 1,
wherein said at least two electric field electrodes (21, 22; 91, 92) and said at least one magnetic field electrode (21, 22; 93, 94) are all provided on the same surface of a single substrate (25; 98).

5. Microfluidic device as claimed in claim 1,
wherein said electrodes (21, 22; 51, 52) are arranged in parallel.

6. Microfluidic device as claimed in claim 1,
wherein said electrodes (21, 22; 51, 52) are arranged coplanar.

7. Microfluidic device as claimed in claim 1,
further comprising a control unit (82; 100) for controlling said voltage source (74; 95) and said current source (78, 79; 96, 97) to simultaneously provide said electric potential and electric current, respectively, to said electrodes.

8. Microfluidic device as claimed in claim 1,
wherein said voltage source and said current source are a common power source (23) for providing said electric potential and said electric current.

9. Microfluidic device as claimed in claim 1,
further comprising an impedance element (64), in particular a resistor, at ends of said at least two electric field electrodes (61, 62).

10. Microfluidic device as claimed in claim 1,
wherein the thickness of said electrodes is larger than 1 μm, in particular larger than 5 μm.

11. Method for pumping of high conductivity liquids comprising the steps of:
providing an electrically conductive liquid, in particular a liquid having a high conductivity, in a microfluidic channel,
generating electric fields by at least two electric field electrodes (21, 22; 71, 72; 91, 92),
generating a magnetic field in a direction substantially perpendicular to said electric fields by at least one magnetic field electrode (21, 22; 75, 76; 93, 94),
providing electric potentials to said at least two electric field electrodes (21, 22; 71, 72; 91, 92) for generating said electric fields,
providing an electric current to said at least one magnetic field electrode (21, 22; 75, 76; 93, 94) for generating said magnetic field, wherein said electric potential and said current are simultaneously provided to said electrodes to obtain a Lorentz force acting on the high conductivity liquid in the direction of said microfluidic channel.
